(19) United States
(12) Patent Application Publication
(10) Pub. No.: US 2022/0073362 A1
(43) Pub. Date: Mar. 10, 2022

(54) AUTOMOBILE EXHAUST GAS BOTTLE- REACTOR THAT ABSORBS CARBON DIOXIDE

(71) Applicant: Ryan Joongi Cho, Seoul (KR)

(72) Inventor: Ryan Joongi Cho, Seoul (KR)

(21) Appl. No.: 17/013,551

(22) Filed: Sep. 5, 2020

(51) Int. Cl. C01F 11/18; B01D 53/62

(52) U.S. Cl. CPC C01F 11/181; B01D 53/62; B01D 2251/404; B01D 2221/14; B01D 2257/504; B01D 2258/01

(57) ABSTRACT

Provided is an automobile exhaust gas bottle-reactor having a carbon dioxide capture device or an exhaust gas carbon dioxide reactor to reduce the emission of carbon dioxide. The exhaust gas carbon dioxide reactor may include a calcium hydroxide inlet through which calcium hydroxide is provided to the carbon dioxide capture device, a calcium carbonate outlet allowing the calcium hydroxide to be discharged from the carbon dioxide capture device, a calcium carbonate partition membrane 6 partitioning the calcium carbonate, a calcium carbonate sensor 7 sensing a level of the calcium carbonate, a calcium hydroxide partition membrane partitioning the calcium hydroxide and a calcium hydroxide sensor sensing a level of the calcium hydroxide.

### TECHNICAL FIELD

This invention is related to an automobile exhaust gas bottle-reactor having a carbon dioxide capture device to thus reduce the emission of carbon dioxide.

### BACKGROUND

Global warming causes a substantial amount of meteorological disasters in the world. The amount of green-house gases that have been absorbed in the atmosphere of earth is increasing resulting from the industrialization. Thus, the overall temperature of the globe continues to increase.

The increase in the earth temperature caused abnormal meteorological changes and a lot of glacier in Antarctic corresponding to approximately 30% of Korean territory disappeared for the last 30 years. The water level is also increased by 25 cm for 100 years and residents in islands in Southern Pacific Ocean moved to New Zealand, giving up their own islands, which was considered a serous disaster and try to find a solution. A research has revealed that the average temporary in the earth will increase by 5.8° C. and the water level will increase by 88 cm.

Eventually, as the consumption of fossil fuel is increased by human beings, the atmosphere CO₂ amount is also increased, thereby resulting in the increase in the earth temperature.

In order to reduce the global warming, Kyoto protocol was issued as the Climatic Change Convention, and this enlightened that the global warming is the most serious environmental problem we have encountered. In particular, since the Kyoto protocol adopted the flexibility provision through which the right to emit CO₂ may be subject to the transaction, the reduction of CO₂ has become entomic issue in addition to the environmental issue.

Accordingly, an innovative idea to reduce the emission of CO₂ is necessary. In addition, this is not merely by scientists, but every person may also need to participate in those activities for reducing the CO₂ emission and energy saving.

Therefore, as we conduct the research on eco-friendly deicing materials, it has been found that many eco-friendly deicing materials contain carbonate ion. But these ions may have a negative effect on global warming. Therefore, a method has been investigated to reduce the CO₂ generation during the process of making deicing materials.

General CO₂ storing techniques include oceanic storage, mineral carbonateion, and underground storage. CO₂ is deposited in the oceanic storage in a state of a hydrate in the ocean to store it, but this has never been tried. On the contrary, CO₂ is melted into a stratum in a super critical fluid state and has been used widely in advanced countries along with the development of gasoline and mineral gas.

### SUMMARY

In recent years, the abnormal temperature due to the increase in CO₂ concentration and the decreased acidity of sea have a substantial impact on marine ecosystem. Various techniques to absorb CO₂ as an attempt to solve these problems have been introduced, but little methods have been used to absorb or remove CO₂ generated from automobile exhaust. Thus, an exhaust gas reactor attached to the exhaust bottle and capable of absorbing or removing CO₂ is described in greater detail in the present invention.

Once again, among the techniques to absorb CO₂, not many techniques have been used to remove CO₂ from the automobile exhaust. This is because the absorbing device is relatively large and there exist difficulties to exchange the reaction materials and the end product in an easy manner.

Therefore, an exhaust gas carbon dioxide reactor may be one of the mineral carbonatization techniques, where a metallic oxide of calcium and magnesium is reacted with CO₂, thereby generating insoluble metal carbonate and removing CO₂. Here, calcium oxide (CaO) and magnesium oxide (MgO) are reacted with the automobile exhaust to thus generate calcium carbonate (CaCO₃) that is eco-friendly and can be used as a deicing material while removing CO₂ in an efficient way.

Therefore, according to the present invention, a calcium hydroxide liquid absorbent may be used to remove CO₂. The CO₂ is infused to the calcium hydroxide liquid absorbent vessel, and it is precipitated as a CaCO₃ solution, and therefore CO₂ is removed therefrom. In other words, the exhaust gas carbon dioxide reactor according to an embodiment of the present invention may generate the calcium carbonate (CaCO₃) solution that is useful and simultaneously reduce CO₂ exhaust.

### BRIEF DESCRIPTION OF THE DRAWINGS

The accompanying drawings are included to provide a further understanding of the present invention and are incorporated in and constitute a part of this specification. The drawings illustrate exemplary embodiments of the present invention and, together with the description, serve to explain principles of the present invention. In the drawings:

FIG. 1 is a view illustrating an exhaust gas carbon dioxide reactor according to an embodiment of the present invention; and

FIGS. 2A to 2C are views illustrating images of an exhaust gas carbon dioxide reactor according to an embodiment of the present invention.

### DETAILED DESCRIPTION OF THE DISCLOSURE

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Terms or languages defined in the present disclosure may have different meaning according to the users' intention or practice. These terms should be interpreted as a meaning corresponding to the technical concept of the present invention disclosed throughout the specification of the present invention.

As used herein, the singular forms “a,” “an,” and “the” are intended to include the plural forms as well, unless the context clearly indicates otherwise. In addition, the expressions defining the relationship of elements or components should be interpreted as broad as possible. For example, it will be understood that when an element or layer is referred to as being “on,” “connected to,” “coupled to,” or “adjacent to” another element or layer, it can be directly on, connected, coupled, or adjacent to the other element or layer, or intervening elements or layers may be present therebetween.

It will also be understood that when an element is same or identical to another element, the element can be completely same or identical to another element, or it includes that the two elements may be “substantially” similar to each other. In the same manner, for the expression showing the equivalence of time such as “simultaneously” or “at the same time,” it should be understood that it happens completely at the same time, or they may happen at substantially the similar time.

The same reference denotations may be used to refer to the same or substantially the same elements throughout the specification and the drawings.

Hereinafter, an exhaust gas carbon dioxide reactor 3 according to embodiments of the present invention will be described in detail with reference to the accompanying drawings.

The exhaust gas carbon dioxide reactor 3 according to an embodiment of the present invention is connected to a car exhaust filter 2 for filtering the automobile exhaust. Here, the car exhaust filter 2 may be connected to a car exhaust pipe 1 through which automobile exhaust is discharged and may be placed downstream of the car exhaust pipe 1.

The exhaust gas carbon dioxide reactor 3 connected to the car exhaust filter 2 is responsible for capturing CO₂ from the automobile exhaust.

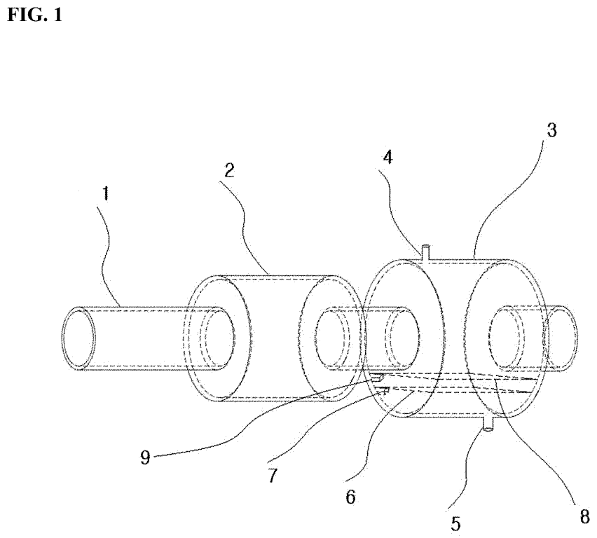

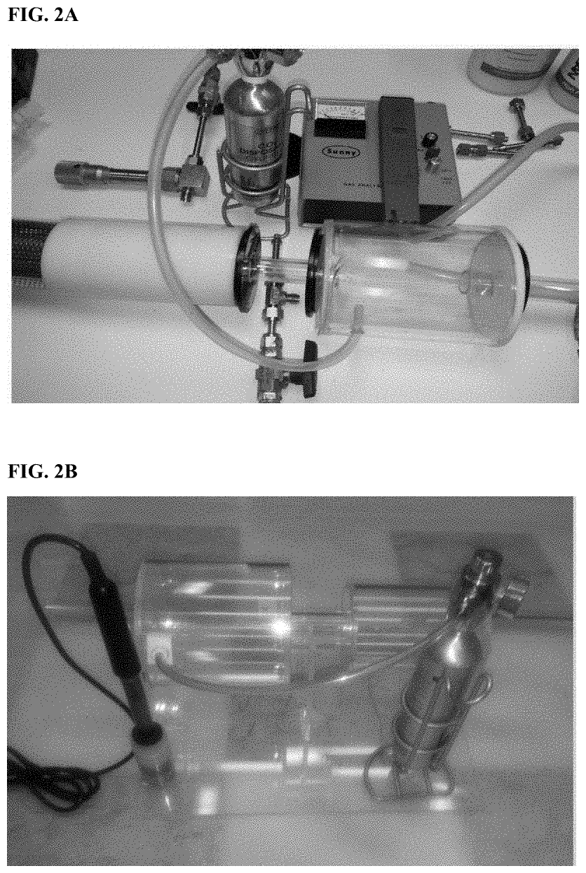

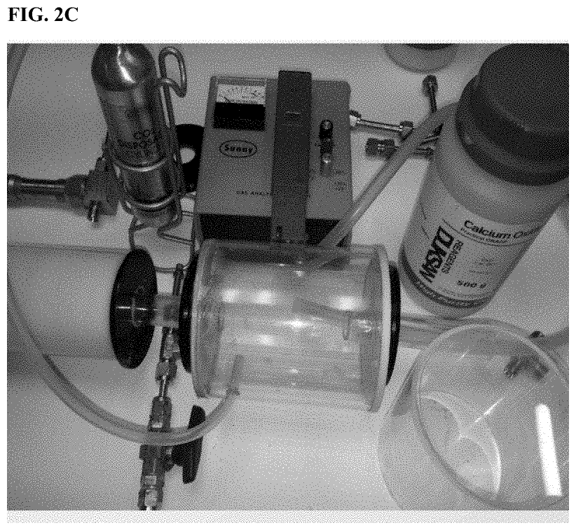

FIG. 1 is a view illustrating the exhaust gas carbon dioxide reactor 3 according to an embodiment of the present invention.

The exhaust gas carbon dioxide reactor 3 may include:

a calcium hydroxide inlet 4 through which calcium hydroxide is provided to the carbon dioxide capture device 3;

a calcium carbonate outlet 5 allowing the calcium hydroxide to be discharged from the carbon dioxide capture device 3;

a calcium carbonate partition membrane 6 partitioning the calcium carbonate;

a calcium carbonate sensor 7 sensing a level of the calcium carbonate;

a calcium hydroxide partition membrane 8 partitioning the calcium hydroxide; and

a calcium hydroxide sensor 9 sensing a level of the calcium hydroxide.

The operation of the exhaust gas carbon dioxide reactor 3 is described below.

As aforementioned, CO₂ is reacted with calcium oxide (CaO) to thus create calcium carbonate (CaCO₃).

The CO₂ is infused to the exhaust gas carbon dioxide reactor 3 to be reacted with calcium hydroxide (Ca(OH)₂) in a proximity of the calcium hydroxide partition membrane 8.

The reacted CO2 and Ca(OH)₂ precipitates in a form of calcium carbonate (CaCO₃) which is collected below the calcium carbonate partition membrane 6. When the calcium carbonate (CaCO₃) is built to the calcium carbonate partition membrane 6, the level is detected by the calcium carbonate sensor 7 to open the calcium carbonate outlet 5, thereby allowing it to be stored in a calcium carbonate storage tank.

Here, when the calcium hydroxide is detected by the calcium hydroxide sensor 9, the calcium carbonate outlet 5 is closed, and instead, the calcium hydroxide inlet 4 is opened to supply the calcium hydroxide to the exhaust gas carbon dioxide reactor 3. In addition, when the calcium hydroxide is detected by the calcium hydroxide sensor 9, the calcium hydroxide inlet 4 is closed again.

Metal oxides such as calcium oxide is reacted with carbon dioxide to produce insoluble calcium carbonate, as shown in Equations 1 and 2.

CaO(s)+H₂O—Ca(OH)₂ (Eq.1)

Ca(OH)₂(s)+CO₂(g)-CaCO₃(s) (Eq.2)

The resulting calcium carbonate will be useful because it is an important ingredient in certain industrial products.

While many technologies have been developed and commercialized for capturing and using carbon dioxide, methods for removing carbon dioxide from car exhaust have not been actively developed. It is difficult to mount a carbon dioxide collecting device inside a car and efficiently remove the resultants from it. A method is disclosed to fix alkaline earth metal-based chemical absorbent to a silicon support, thereby allowing the carbon dioxide to be absorbed.

### Advantageous Effects

In the present invention, calcium hydroxide reacts with carbon dioxide to produce another substance. When carbon dioxide enters the absorption column, it becomes a calcium carbonate solution and precipitates on the bottom. This process effectively reduces carbon dioxide from car exhaust. Therefore, this invention can be described as an eco-friendly device due to its ability to transform a greenhouse gas into a useful industrial compound.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An exhaust gas carbon dioxide reactor, comprising:
a calcium hydroxide inlet through which calcium hydroxide is provided to the exhaust gas carbon dioxide reactor;
a calcium carbonate outlet allowing the calcium hydroxide to be discharged from the exhaust gas carbon dioxide reactor;
a calcium carbonate partition membrane partitioning the calcium carbonate;
a calcium carbonate sensor sensing a level of the calcium carbonate;
a calcium hydroxide partition membrane partitioning the calcium hydroxide; and
a calcium hydroxide sensor sensing a level of the calcium hydroxide.
